(19) United States
(12) Patent Application Publication
(10) Pub. No.: US 2014/0098629 A1
(43) Pub. Date: Apr. 10, 2014

(54) DEVICE FOR THE LOW-BUBBLE MIXING AND DISCHARGING OF A PRODUCT

(71) Applicant: Andy Greter, Rotkreuz (CH)

(72) Inventor: Andy Greter, Rotkreuz (CH)

(73) Assignee: Medmix Systems AG, Rotkreuz (CH)

(21) Appl. No.: 14/115,950

(22) PCT Filed: May 22, 2012
(86) PCT No.: PCT/CH2012/000116

§ 371 Date: Nov. 22, 2013

(30) Foreign Application Priority Data
Jun. 22, 2011 (CH) 1056/11

(51) Int. Cl. B01F 15/02

(52) U.S. Cl. CPC B01F 15/0278
USPC 366/184

(57) ABSTRACT

A device is proposed for low-bubbling mixing and discharge of a product. The device comprises a housing (10) which delimits a reservoir for the product. In the reservoir, a mixing element (23) is moveable in order to mix the product. A piston (40) delimits the reservoir in the proximal direction and is displaceable into the distal direction in order to discharge the product from the reservoir. In order to force gases out of the reservoir and thereby prevent bubble formation, the device has a spring element (50) which loads the piston with a spring force in the distal direction.

### FIELD OF THE INVENTION

The present invention relates to a device for thoroughly mixing a product and subsequently discharging it from the device. The product can, in particular, be a product comprising two components, for example a powdery component and a liquid component. In particular, the device is suitable for producing and discharging bone cement.

### STATE OF THE ART

From WO 2009/105905 a syringe-like device for the mixing and discharging of a product comprising two or more components is known. The device comprises a syringe receptacle with a piston displaceably arranged therein. The syringe receptacle and the piston together delimit a reservoir for the components. An actuating rod leads through the piston. At the distal end of the actuating rod there is a mixing element within the reservoir, which mixing element can be moved to and fro in the reservoir by means of the actuating rod in order to mix the components. At the proximal end of the actuating rod a coupling element in the form of a laterally open sleeve-like piston rod is pivotably affixed. The coupling element can be pivoted over the actuating rod in such a manner that it fixes the piston to the mixing element, thus coupling the mixing element to the piston. In this manner the piston together with the mixing element can be advanced in the distal direction in order to discharge the finished product from the reservoir.

In such a device there is the possibility of air and/or other gases, for example gases which can arise as a result of a chemical reaction of the components, being present in the reservoir. During the mixing of the components the aforesaid can result in the formation of bubbles in the product to be discharged. This is undesirable.

In order to prevent bubble formation, various devices are known from the state of the art, in which devices the mixing process takes place while negative pressure is applied to the reservoir. One example of such a device is stated in US 2008/0144428. However, such devices necessitate a vacuum pump. Furthermore, because of the required vacuum hose, handling such a device is rendered more difficult.

### PRESENTATION OF THE INVENTION

In a first aspect of the present invention it is thus an object to provide a mixing device and discharge device in which bubble formation is reduced even without the application of negative pressure. This object is met by a device with the features of claim 1. Further embodiments are indicated in the dependent claims.

The invention thus provides a device for the mixing and discharging of a product, comprising:
a housing which delimits a reservoir for the product;
a mixing element which is movable in the reservoir in order to mix a product accommodated therein; and
a piston which delimits the reservoir to a proximal end and is displaceable into a distal direction relative to the housing in order to discharge the product from the reservoir in the distal direction.

According to the invention, the device comprises a spring element which is adapted to load the piston relative to the housing in the distal direction with a spring force.

By providing such a spring element it can be ensured that already prior to commencement of the mixing process the piston rests tightly against the product to be mixed, or against the components to be mixed, and that essentially there is no longer any air in the reservoir. In this manner the bubble formation during mixing is reduced. Furthermore, this device makes it possible for other gases, which may arise in the course of chemical reactions in the product to be mixed, to be removed from the reservoir.

In order to facilitate filling the device, preferably a fixing device is provided in order to fix the piston relative to the housing in a holding position, wherein in this holding position the spring element is pre-tensioned. In this manner it is, in particular, possible to fill the reservoir while the piston is fixed in the holding position. When the piston is subsequently released from the holding position, the spring element pushes the piston forward in the distal direction, thus pressing out of the reservoir any air which may still be in the reservoir after the filling process. Possible specific designs of the fixing device will be described in more detail below.

In order to make it possible, during movement of the piston in the distal direction as a result of the spring element, for air and other gases to escape from the reservoir, the device preferably comprises at least one ventilation opening. The aforesaid is preferably designed in such a manner that it allows gases to escape, while preventing any escape of powdery or paste-like solids. To this effect the ventilation opening can, for example, comprise a cross section which is sufficiently small, which cross section prevents the escape of particles of a provided powdery component, or, it is possible, for example, for a filter to be inserted in the ventilation opening. Such a ventilation opening makes it possible for the piston, under the effect of the spring element, to press the gas remaining in the reservoir from the reservoir without in this process the product to be mixed also being pressed from the reservoir. The ventilation opening can also, in addition, be used for supplying and leading away a gas for sterilisation, for example ethylene oxide. In this case the use of a filter in the ventilation opening is particularly preferred.

Preferably, the ventilation opening is arranged on the piston. In this context it is conceivable for the ventilation opening to be provided as a through-opening in the body of the piston itself; however, it is also conceivable to provide such an opening between an outer circumferential region of the piston and a circumferential sidewall of the container. Preferably, however, the ventilation opening is designed so as to be between the piston and the actuating element for the mixing element, wherein the actuating element penetrates the piston.

In an advantageous embodiment the ventilation opening can be closed by the mixing element and/or the actuating element. In this regard reference is made to patent application PCT/CH 2011/00135 of Jun. 7, 2011, whose content by reference is completely incorporated herein. The mixing element or the actuating element in this case thus acts as a valve for the ventilation opening. However, a valve for the ventilation opening can also be designed in some other manner. In particular it can also be a one-way valve which, while allowing the escape of gases from the reservoir, nevertheless prevents any ingress of gases into the reservoir. In that the ventilation opening can be closed by a valve, it is, in particular, possible to withdraw the piston in the housing in the proximal direction, thus generating negative pressure in the reservoir, without, as a result of this, air being drawn in through the ventilation opening. This can be useful in order to draw a liquid component into the reservoir through some other opening in the reservoir. A valve effect is also advantageous when it is provided, for the purpose of sterilisation, to feed a gas to the reservoir through some other opening, in particular through a suitable filter. The valve then prevents uncontrolled discharge of the gas.

As already mentioned the mixing element is preferably connected to an actuating element which penetrates the piston. The actuating element then projects in the proximal direction from the reservoir. The device can furthermore comprise a coupling element which can be brought to a state in which it fixes the actuating element in terms of a distal direction (which is opposite to the proximal direction) relative to the housing. As a result of this the actuating element, and/or the mixing element connected thereto, can hold the piston in a holding position in which the spring element is pre-tensioned. In this case the piston is thus prevented, by the mixing element, from moving into the distal direction as a result of the spring force. In this regard the mixing element, the actuating element and the coupling element together thus form the above-mentioned fixing device for the piston.

However, a fixing device for the piston is advantageous also if there is no spring element. This can be advantageous in order to fix the piston, for example during filling at negative pressure or during sterilisation with a gas and the subsequent suction removal of the gas. Accordingly, according to a second aspect the invention also relates to a device for the mixing and discharging of a product, which device comprises:
a housing which delimits a reservoir for the product;
a piston which delimits the reservoir to a proximal end and is displaceable into a distal direction relative to the housing in order to discharge the product from the reservoir in the distal direction;
a mixing element which is movable in the reservoir in order to mix a product accommodated therein;
a fixing device in order to fix the piston relative to the housing at least in terms of a movement in the distal direction.

If the device comprises an actuating element connected to the mixing element, which actuating element penetrates the piston and in the proximal direction projects from the reservoir in order to move the mixing element in the reservoir, the fixing device can, in particular, comprise the already mentioned coupling element which can be brought to a state in which it fixes the actuating element in terms of at least the distal direction relative to the housing so that the actuating element and/or the mixing element hold/holds the piston at least in terms of the distal direction in a holding position.

Preferably, the coupling element is furthermore designed to couple the mixing element to the piston in that it fixes the mixing element relative to the piston. To this effect the coupling element can be attached, proximally from the piston, to the actuating element in such a manner that the piston is held between the coupling element and the mixing element. In this manner it becomes possible, by means of the coupling element, to move the piston into the distal or proximal direction, provided the coupling element is in a state in which it fixes the actuating element only relative to the piston, but not relative to the housing. In this case the coupling element thus acts as a piston rod for the piston.

In particular, in the piston a central through-opening can be provided through which the actuating element projects. In a specific design the actuating element can, in particular, form an actuating rod, and the coupling element can then form a laterally open (open laterally across the direction of movement of the piston) hollow piston rod which is laterally movably by way of the actuating element and which can be fixed to the actuating element in such a manner that it rests against a proximal region of the piston. Such a design of the actuating element and of the coupling element has, in particular, been disclosed in the already mentioned WO 2009/105905, wherein in the present context it is, however, preferred if the coupling element is not hinged to the actuating element but is removable from the actuating element. Such a design has, furthermore, also been disclosed in the already mentioned application PCT/CH 2011/00135 of Jun. 7, 2011.

Irrespective of the specific design of the actuating element and of the coupling element it is preferable if the device comprises a detachable locking device which in the holding position fixes the coupling element relative to the housing in such a manner that the locking device blocks movement of the coupling element at least in the distal direction, while the locking device in a release position allows movement of the coupling element together with the actuating element in the distal direction. The locking device can form a detachable snap-on connection between the coupling element and the housing or an element fixed to the housing, and can, in particular, comprise a locking catch at the coupling element. Said locking catch in its holding position then preferably engages the housing, or an element fixed to the housing, in order to prevent any movement of the coupling element in the distal direction. The locking device can then be moved to the release position, for example by pushing-in or removing the locking catch. A multitude of other locking devices are conceivable, as will be explained in more detail below.

The actuating element can comprise a joint which makes it possible to remove a proximal part of the actuating element in a targeted manner. Said joint can, for example, be a predetermined breaking point in order to break off the proximal part of the actuating element in a targeted manner, or it can be a screw connection in order to unscrew the proximal part of the actuating element. This makes it possible to slide a press-out element onto the remainder of the actuating element, which serves to exert a press-out force on the piston in the distal direction, in order to discharge the product from the reservoir.

In particular, such a press-out element can be adapted to establish a threaded connection with a counterpart which is fixed to the housing, for example with a threaded bushing fixed to the housing. In particular, the counterpart can comprise an internal thread, and in this case the press-out element can comprise an external thread which can be made to engage the internal thread. In particular, the press-out element preferably comprises a hollow threaded spindle with an external thread, wherein the hollow space is suitable for accommodating part of the actuating element.

The counterpart fixed to the housing is preferably designed in one piece with the housing and is arranged in a region which is situated proximally to the piston. However, it is also conceivable to design such a counterpart so that it is separate from the housing, and for example to snap it or screw it onto the housing.

According to a further aspect, the present invention also relates to a device for the mixing and discharging of a product, comprising:
a housing which delimits a reservoir for the product;
a piston which delimits the reservoir to a proximal end and is displaceable into a distal direction relative to the housing in order to discharge the product from the reservoir in the distal direction; and
a press-out element to exert a press-out force on the piston into the distal direction, wherein the press-out element is adapted to establish a threaded connection with a counterpart which is arranged proximally to the piston and which is fixed to the housing.

In this arrangement it is proposed that the counterpart which is fixed to the housing be designed so as to be non-detachable and preferably in a single piece with the housing. While in the state of the art it is known per se to use a press-out element in the form of a threaded spindle, said press-out element in the state of the art normally interacts with a counterpart that is designed so as to be separate from the housing, which counterpart can, for example, be snapped onto the housing. In that the counterpart which is fixed to the housing is designed so as to be non-detachable or even in one piece with the housing, both manufacture and handling of the device are simplified. It is no longer necessary to separately snap the counterpart for the press-out element onto the housing, instead the press-out element (which can, in particular, be present in the form of a threaded spindle) can directly be screwed into the housing.

Such a device, too, preferably comprises a mixing element which is movable in the reservoir in order to mix a product accommodated therein. The mixing element in turn is preferably connected to an actuating element which penetrates the piston and projects from the reservoir in the proximal direction in order to move the mixing element in the reservoir. In this more general embodiment, too, the actuating element preferably comprises a predetermined breaking point for breaking off a proximal part of the actuating element so that the press-out element can be slid onto the remainder of the actuating element. However, the press-out element can also be slidable onto the entire actuating element. The further considerations set out above in the context of the first aspect of the invention analogously also apply to the second aspect of the invention.

The device according to the invention can, in particular, be present as a kit which on the one hand comprises the housing with the piston situated therein, and if applicable comprises the further elements mentioned, and on the other hand comprises the press-out element as a separate part.

### BRIEF DESCRIPTION OF THE DRAWINGS

Below, preferred embodiments of the invention are described with reference to the drawings, which are merely intended for clarification and are not to be interpreted as being limiting. The following are shown in the drawings:

FIG. 1 a mixing and discharging device according to a preferred exemplary embodiment during filling;

FIG. 2 a central longitudinal section of the device of FIG. 1 in region II of FIG. 1;

FIG. 3 a view of the device of FIG. 1 after filling in its closed state;

FIG. 4 a central longitudinal section of the device of FIG. 1 after removal of the coupling element;

FIG. 5 a central longitudinal section of the device of FIG. 1 after the mixing process, wherein the proximal end of the actuating element has been removed;

FIG. 6 a central longitudinal section of the device of FIG. 1 during discharge with the press-out element screwed in;

FIG. 7 a central longitudinal section of the device of FIG. 1 during filling with another filling method; and

FIG. 8 a central longitudinal section of the device of FIG. 1 during filling with yet another filling method.

### DESCRIPTION OF PREFERRED EMBODIMENTS

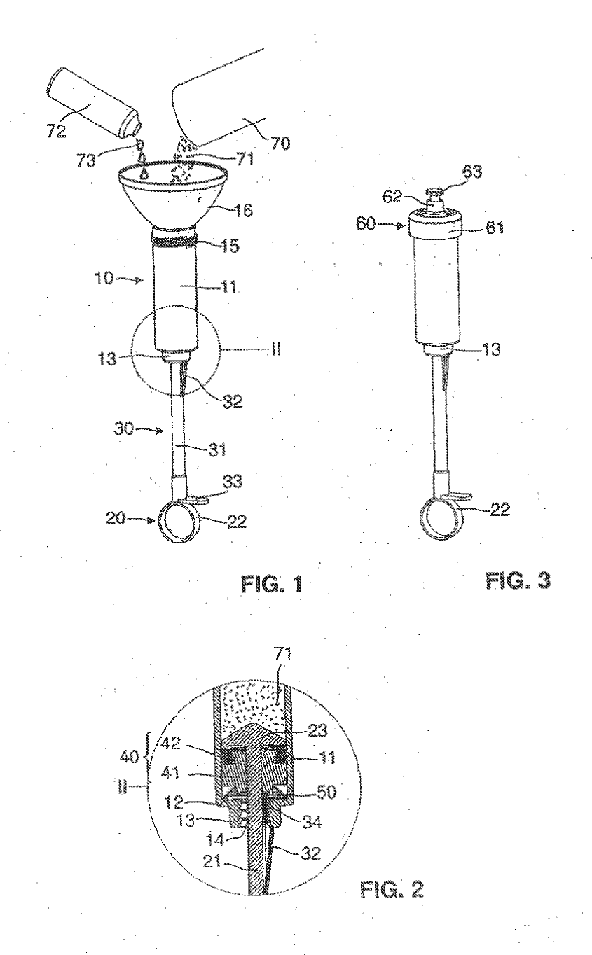

FIGS. 1 to 6 illustrate a preferred exemplary embodiment of a mixing and discharging device according to the invention. The device comprises a housing 10 with a circumferential cylindrical sidewall 11. At its distal end (in FIG. 1 this is the upper end) the housing 10 is open. At its proximal end there is a proximal end wall 12, which in the proximal direction is followed by a threaded bushing 13 with an internal thread 14. In the region of the internal thread 14 the end wall 12 and the threaded bushing 13 together form a through-opening through which an actuating rod 21, which will be described in more detail below, for a mixing element 23 reaches.

In the housing 10 a piston 40 is displaceably arranged. The piston comprises a carrier 41 with an elastic sealing element 42 arranged thereon. In this arrangement the sealing element sealingly rests against the circumferential sidewall 11 of the housing 10. As a result of this, the piston 40 together with the housing 10 delimits a reservoir for accommodating components 71, 73.

The carrier 41 and the sealing element 42 of the piston 40 each comprise a central bore through which an actuating element in the form of the already mentioned actuating rod 21 leads. At its distal end the actuating rod 21 is connected to a mixing element 23. In this arrangement the mixing element comprises, for example, four radially-outward-extending arms that can be connected to a circumferential ring which extends concentrically to the actuating rod 21, or to four separate ring segments. However, the mixing element can also be designed in some other manner that is known per se from the state of the art, for example as a plate comprising several through-openings. The mixing element 23 serves to mix the components 71, 73 contained in the reservoir in that said mixing element 23 is moved to and fro in the reservoir, and if applicable is also rotated. To this effect the actuating rod 21 at its proximal end is connected to an actuating ring 22. The actuating rod 21, the actuating ring 22 and the mixing element 23 thus overall form a mixing device 20.

Between the proximal end wall 12 of the housing 10 and the carrier 41 of the piston 40 a spirally wound coil spring 50 from a suitable material, for example spring steel, is arranged. In the position of FIGS. 1 to 3 this spring is compressed, thus exerting a force in the distal direction on the piston 40. In order to prevent the spring 50 from relaxing, thus pushing the piston 40 in the distal direction, the device comprises a coupling element 30 which forms a laterally-open sleeve 31. In FIGS. 1-3 this sleeve 31 has laterally been pushed over the actuating rod 21. With its distal end 34 said sleeve 31 projects into the through-opening at the proximal end of the housing 10 where it rests against the carrier 41 of the piston 40. With its proximal end the sleeve 31 rests against the actuating ring 22; in this region a grip lug 33 is arranged on the sleeve 31. Overall, the coupling element 30 in this manner fixes the piston 40 between the sleeve 31 and the mixing element 23 thus coupling the piston 40 to the mixing element 23 and to the actuating rod 21.

Near the distal end of the sleeve 31, at the coupling element 30 a locking device in the form of a pawl or locking catch 32 is arranged which laterally projects beyond the sleeve 31 and forms an end stop with the threaded bushing 13 fixed to the housing. In this manner the coupling element 30 prevents the actuating rod 21 and the mixing element 23 connected thereto from being able to be moved in the distal direction into the reservoir. The piston 40 rests against the mixing element 23 and is thus likewise prevented from moving in the distal direction. Overall, in this manner the piston 40 is fixed, relative to the housing 10, in a holding position in which the spring element 50 is pre-tensioned. In this arrangement the coupling element 30 with the locking catch 32, the actuating rod 21 and the mixing element 23 thus together form a fixing device in order to fix the piston 40 to the housing.

In that the piston 40 is held in the holding position of FIG. 2 it becomes possible to fill the device in the manner shown in FIG. 1. To this effect a filling funnel 16 has been placed in the open distal end of the housing 10, by means of which filling funnel 16 it is possible, for example, from a powder container 70 to fill a powdery component 71 and from a liquids container 72 to fill a liquid component 73 into the reservoir. After the components have been placed in the reservoir, the funnel 16 is removed and the reservoir is closed by means of a cover 60. In this arrangement the cover 60 comprises a circumferential skirt 61 on the inside of which an internal thread has been formed that engages an external thread 15 on the outside of the sidewall 11 of the housing 10. The cover moreover comprises a discharge nipple 62 that forms a discharge opening which is closed by a closing device 63. To this effect the discharge nipple 62 comprises an internal thread which is engaged by an external thread of the closing device 63. After the components 71, 73 have been put into place and the reservoir has been closed by means of the cover 60, the state as shown in FIG. 3 results. As an alternative, the device can already be prefilled with a component, preferably with the powdery component.

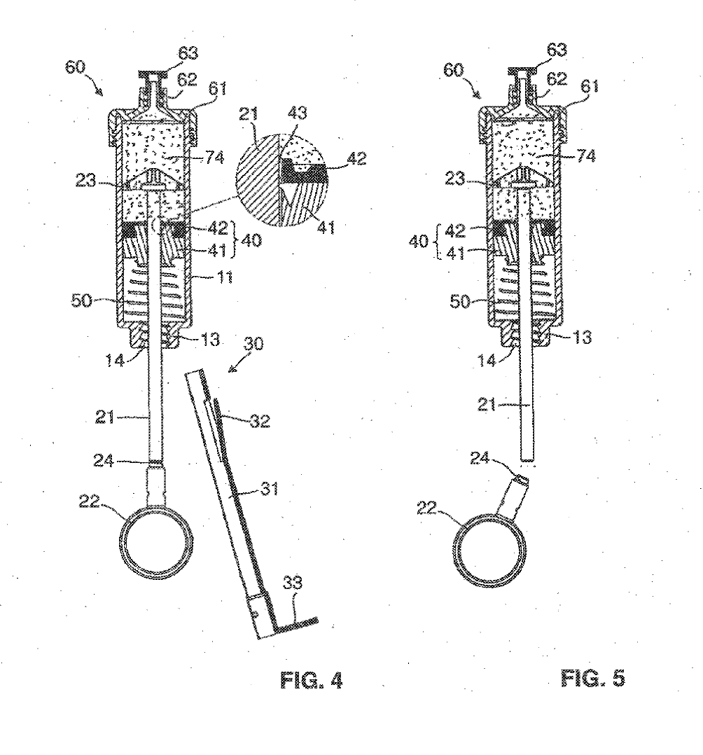

In order to mix the components that have been placed in the reservoir, the coupling element 30 is removed from the actuating rod 21, as shown in FIG. 4. As a result of this the actuating rod 21 with the mixing element 23 can then move relative to the piston 40 in the distal direction. Since the piston 40 is no longer prevented by the mixing element 23 from moving in the distal direction, the piston 40 can then move in the distal direction under the effect of the spring 50.

Between the piston 40 and the actuating rod 21 there is at least one ventilation opening 43 (refer to the enlarged section in FIG. 4; in the present example there are preferably three or four ventilation openings which are arranged equidistantly in the circumferential direction). During the filling process the ventilation opening was closed by the mixing element 23. After release of the mixing element 23 and of the piston 40, gases that have built up in the reservoir can then exit to the outside through the ventilation opening 43 under the effect of the spring-loaded piston 40. In this arrangement the ventilation opening 43 has been selected to be sufficiently small to prevent at least the powdery component 71 from exiting to the outside through this opening. A liquid component 73 in turn is, as a rule, absorbed by the powdery component 71 to such an extent that it never reaches the ventilation opening 43. In this manner in practical application only gases exit to the outside through the ventilation opening 43.

As a result, the spring 50 thus pushes the piston 40 in the distal direction to such an extent that gases, in particular air, which are present in the reservoir are largely pressed from the reservoir. To this extent, the effect of the spring 50 is similar to the effect of negative pressure applied to the reservoir, in that in this manner the predominant part of the gases present are removed from the reservoir. This effect is, however, achieved in a much simpler manner as compared to the application of negative pressure.

There are several options for discharging the finished product 74 after mixing. A first option consists of withdrawing the actuating rod 21 again to such an extent in the proximal direction that the mixing element 23 comes to rest against the piston 40, and to again affix the coupling element 30 to the actuating rod 21. This may necessitate manually pushing the locking catch 23 inwards so that the locking catch 21 can be inserted into the proximal opening of the housing. The piston 40 is then coupled again, by means of the coupling element 30, to the mixing element 23 and to the actuating rod 21. The closing device 63 can then be removed from the discharge nipple 62, and the product can be discharged through the discharge nipple 62 in that the actuating rod 21 is pushed forward in the distal direction.

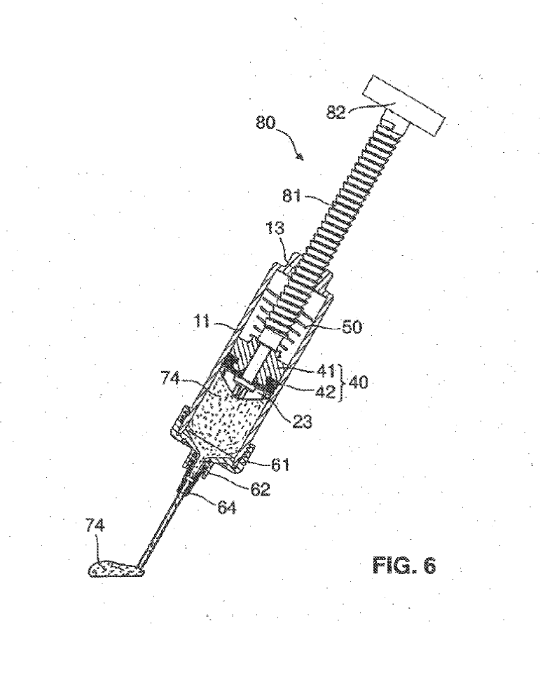

Frequently, however, the finished product 74 will be a highly viscous mass, in particular if the product 74 is, for example, a bone cement. In this case discharge may require greater forces than can be applied by manual pressure onto the actuating rod 21 alone. For these cases a second option for discharging the finished product 74 is available. To this effect the actuating rod 21 comprises a weakened region 24 at which the proximal region of the actuating rod can be removed, in particular broken off, by means of the actuating ring 22. This is illustrated in FIG. 5. As an alternative it is, for example, also conceivable that initially the proximal region of the actuating rod 21 with the actuating ring 22 is screwed onto the remainder of the actuating rod 21 and is unscrewed for discharging. Subsequently it is possible to slide a press-out element 80 in the form of a hollow threaded spindle with an external thread 81 and an actuating handle 82 from the proximal end onto the actuating rod 21, as illustrated in FIG. 6. By means of clockwise rotation of the threaded spindle the external thread 81 engages the internal thread 14 of the threaded bushing 13. Consequently the press-out element 80 can be screwed in the distal direction into the housing 10 until the distal end of the threaded spindle comes to rest against the piston 40, thus pushing said piston 40 forward in the distal direction. In this manner the product 74 can be discharged at a reduced application of force through the discharge nipple 62 and through a hollow needle 64 which has optionally been screwed into this discharge nipple.

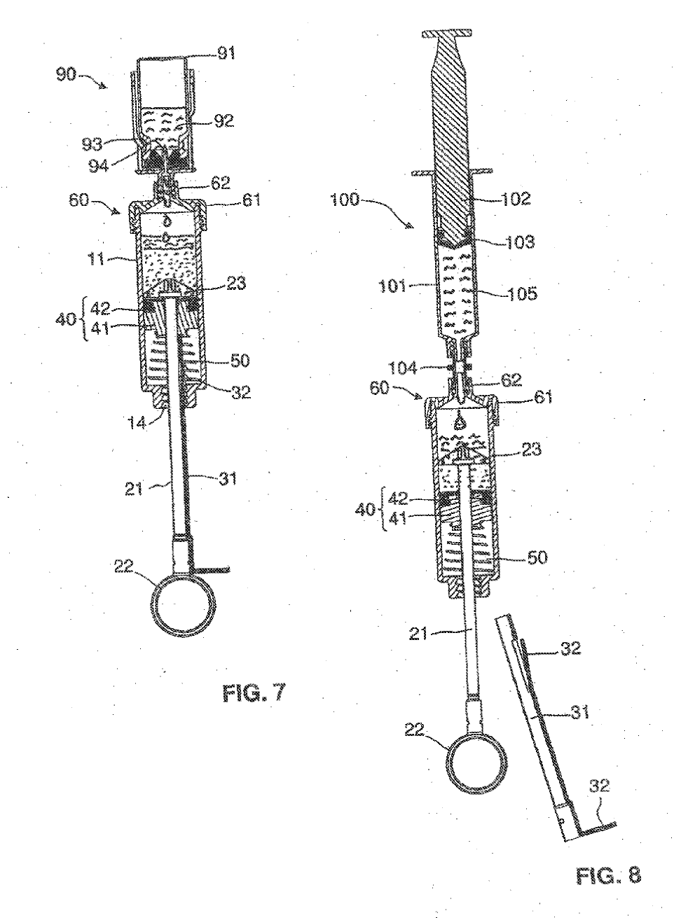

FIG. 7 illustrates an alternative filling option relating to the mixing and discharging device of FIG. 1. The powdery component 71 was previously, for example in the manner shown in FIG. 1, or already at the factory, placed into the reservoir. A vial holder 90 has been screwed into the discharge nipple 62 of the cover 60, in which vial holder 90 a commercially available glass vial 91 with a septum seal has been inserted. In this arrangement a locking arm 93 holds the vial in a position in which a hollow needle 94 penetrates the septum seal of the vial. In this manner a liquid component 92 can reach the reservoir in the housing 10 from the vial through the hollow needle 94 and through the discharge nipple 62.

The actuating rod 21 has been slid onto the coupling element 30; in this arrangement the locking catch 32 of the coupling element 30 is pressed-in in such a manner that it extends into the proximal opening of the housing 10. The spring 50 is at least partly relaxed. The mixing element 23 closes the ventilation opening 43. In order to facilitate filling with the component 92 from the vial 91, a user can then pull rearward the actuating rod 21 with the actuating ring 22 in the proximal direction against the spring force of the spring 50 in order to in this manner generate negative pressure in the reservoir. Consequently the component 92 is sucked into the reservoir. As soon as the user has pulled the actuating rod 21 sufficiently far rearwards for the spring 50 to be completely compressed, the locking catch 32 locks to the housing 10, and the further sequence is then identical to that described above in the context of FIGS. 1 to 6.

FIG. 8 illustrates a third option of filling the reservoir. In this arrangement the powdery component 71 is also already in the reservoir. A liquid component 105 is contained in the syringe body 101 of a syringe 100. The syringe 100 is connected to the discharge nipple 62 by way of an adapter 104. By applying pressure on a piston rod 102 the user can push the syringe piston 103 in the proximal direction so that the liquid component 105 is pushed into the reservoir in the housing 10. In order to ensure that in this process gases can escape from the reservoir, in this case the coupling element 30 is located away from the actuating rod 21 and the mixing element 23 is located at a distance from the piston 40 in order to release the ventilation opening 43.

The above description shows that the device according to the present exemplary embodiment can be used in a multitude of different ways. At the same time it is evident that a multitude of modifications to this device are possible without leaving the scope of the invention.

Thus the concrete design of the coupling element can vary. Further possible embodiments of coupling elements are, for example, stated in WO 2009/105905, wherein, however, in the context of the present invention it is preferred if the coupling element is completely removable from the actuating element. Further variants are also stated in the already-mentioned patent application PCT/CH 2011/000135 of Jun. 7, 2011.

However, it is also possible to use entirely different types of actuating elements and coupling elements to those described in the above exemplary embodiment. For example, it is conceivable to design the coupling between the actuating element and the piston in a manner as described in EP 1 920 738. A multitude of further options of coupling an actuating element for a mixing element to a piston are conceivable.

If a coupling element as shown in the present exemplary embodiment is used, a locking device other than the locking catch 32 can be provided in order to fix the coupling element to the housing. For example, the locking catch 32, which has been designed in one piece with the coupling element, can also be replaced by some other type of locking element, for example by a separately constructed metal spring that is held in a corresponding spring holder of the coupling element. Furthermore, it is conceivable, for example, to provide a simple lug on the outside of the coupling element, which lug in a first orientation of the coupling element engages the housing 10 or an element fixed to the housing, in order to fix the coupling element in terms of movement in the distal direction relative to the housing. In this arrangement a groove or some other structure can be provided on the housing or on the element fixed to the housing, which groove or structure in a second orientation of the coupling element allows movement of the lug in the distal direction. Thus, releasing the piston relative to the housing takes place in that the coupling element is rotated on the longitudinal axis relative to the housing. As an alternative it is also conceivable to provide a locking element in the form of, for example, a locking catch or metal spring not on the coupling element but instead on the housing, wherein this locking element arranged so as to be fixed to the housing then interacts with a corresponding counter structure (for example an indentation or recess) on the coupling element. This could, for example, take place in the manner shown in U.S. Pat. No. 2,474,496, U.S. Pat. No. 2,875,761 or in the application PCT/CH 2010/000300 of 25.11.2010. A multitude of other locking devices for the coupling element are conceivable.

However, coupling between the actuating element and the housing can also be produced in an entirely different manner from that shown in the present exemplary embodiment. For example it is conceivable to provide a detachable connection directly between the actuating element and the housing or an element fixed to the housing, for example in the form of a pin which can be slid into the actuating element, a snap-on connection, a clip that can be slid on, etc.

However, a coupling element which fixes the actuating element and the housing relative to each other can also be omitted altogether. The piston can then be fixed relative to the housing with the use of a completely different kind of fixing device. For example, in the simplest case it is conceivable to fix the piston with a pin that laterally projects through the housing wall, which pin projects into a lateral holding opening of the piston, in a detachable manner to the housing.

While in the present example the ventilation opening 43 is designed between the piston 40 and the actuating rod 21, as is basically also described in the application PCT/CH 2011/000135, the ventilation opening can also be located at some other position, for example on the distal end of the housing 10. In order to prevent any escape of solids and/or liquids, a suitable filter element can be inserted in the ventilation opening. The ventilation opening can be manually closable by means of a valve in order to, if applicable, in a targeted manner achieve negative pressure or positive pressure in the reservoir. If applicable, the ventilation opening can comprise a connector in order to lead a gas for sterilisation, for example ethylene oxide, into the reservoir.

While in the present exemplary embodiment the threaded bushing 13 is designed in a single piece with the remaining housing 10, the threaded bushing 13 can also be designed on a separate component which, for example, can be clipped onto the housing 10 from the proximal end and can be lockable or screwable to said housing 10. Such elements are basically known from the state of the art. Likewise, the distal end of the housing 10 can be designed in a manner other than that shown in this document. In particular when the reservoir is prefilled with a component, for example the cover 60 can be designed in one piece with the housing 10.

Instead of discharging the product with a press-out element in the form of a threaded spindle, it is also conceivable to design the device in such a manner that it can, for example, be inserted in a suitable pistol dispenser. In this case there is no need to provide a threaded bushing. In this respect, too, a multitude of further variation options exist.

Likewise, the spring element 50 can be designed in a manner that differs from that shown in the present exemplary embodiment. For example, instead of a spirally tapering coil spring it is also possible to use a cylindrical coil spring. Similarly, the use of leaf springs or other elastic elements, for example based on elastic plastics or foam materials, is conceivable.

LIST OF REFERENCE CHARACTERS

| | |
|---|---|
| 10 | Housing |
| 11 | Sidewall |
| 12 | Proximal end wall |
| 13 | Threaded bushing |
| 14 | Internal thread |
| 15 | External thread |
| 16 | Funnel |
| 20 | Mixing device |
| 21 | Actuating rod |
| 22 | Actuating ring |
| 23 | Mixing element |
| 30 | Coupling element |
| 31 | Sleeve |
| 32 | Locking catch |
| 33 | Grip lug |
| 34 | Distal end |
| 40 | Piston |
| 41 | Carrier |
| 42 | Sealing element |
| 43 | Ventilation opening |
| 50 | Spring |
| 60 | Cover |
| 61 | Skirt |
| 62 | Discharge nipple |
| 63 | Closing device |
| 64 | Hollow needle |
| 70 | Container |
| 71 | Powdery component |
| 72 | Container |
| 73 | Liquid component |
| 74 | Product |
| 80 | Press-out element |
| 81 | External thread |
| 82 | Actuating handle |
| 90 | Vial holder |
| 91 | Vial |
| 92 | Liquid component |
| 93 | Locking arm |
| 94 | Hollow needle |
| 100 | Syringe |
| 101 | Syringe body |
| 102 | Piston rod |
| 103 | Syringe piston |
| 104 | Adapter |
| 105 | Liquid component |

1. A device for the mixing and discharging of a product, comprising:
a housing which delimits a reservoir for the product;
a mixing element which is movable in the reservoir in order to mix a product accommodated therein; and
a piston which delimits the reservoir to a proximal end and is displaceable into a distal direction relative to the housing (10) in order to discharge the product from the reservoir,
wherein the device comprises a spring element which is adapted to load the piston relative to the housing in the distal direction with a spring force.

2. The device according to claim 1, comprising a fixing device in order to fix the piston relative to the housing in a holding position in which the spring element is pre-tensioned.

3. The device according to claim 1, comprising at least one ventilation opening in order to allow gases to escape from the reservoir.

4. The device according to claim 3, wherein the ventilation opening is designed in such a manner that it prevents any escape of solids, while allowing gases to escape.

5. The device according to claim 3, wherein the ventilation opening is arranged on the piston.

6. The device according to claim 5, wherein the ventilation opening can be closed by the mixing element and/or by an actuating element connected thereto.

7. The device according to claim 1, wherein the mixing element is connected to an actuating element which penetrates the piston and in the proximal direction projects from the reservoir in order to move the mixing element in the reservoir.

8. The device according to claim 7, further comprising a coupling element which can be brought to a state in which it fixes the actuating element in terms of at least the distal direction relative to the housing so that the actuating element and/or the interconnected mixing element hold/holds the piston in a holding position in which the spring element is pre-tensioned.

9. The device according to claim 8, wherein the coupling element is furthermore designed to move the piston in the reservoir, provided the coupling element is in a state in which it does not fix the actuating element relative to the housing.

10. The device according to claim 8, wherein the coupling element can be attached, proximally from the piston, to the actuating element in such a manner that the piston is held between the coupling element and the mixing element.

11. The device according to claim 8, wherein the actuating element forms an actuating rod, and wherein the coupling element forms a laterally-open hollow piston rod which in a lateral direction can be moved by way of the actuating rod and can be fixed to the actuating rod in such a manner that it rests against the piston.

12. The device according to claim 8, comprising a detachable locking device which in the holding position fixes the coupling element relative to the housing in such a manner that the locking device blocks movement of the coupling element at least in the distal direction, while the locking device in a release position allows movement of the coupling element together with the actuating element in the distal direction.

13. The device according to claim 12, wherein the locking device comprises a locking catch designed on the coupling element in such a manner that in the holding position it engages the housing in order to prevent any movement of the coupling element in the distal direction.

14. The device according to claim 7, wherein the actuating element comprises a joint in order to remove a proximal part of the actuating element.

15. The device according to claim 7, further comprising a press-out element, preferably slidable onto at least part of the actuating element, in order to exert a press-out force on the piston into the distal direction, wherein the press-out element is designed to establish a threaded connection with a counterpart fixed to the housing.

16. The device according to claim 15, wherein the counterpart which is fixed to the housing is designed in one piece with the housing and is arranged in a region of the housing which is situated proximally to the piston.

17. A device for the mixing and discharging of a product, comprising:
a housing which delimits a reservoir for the product;
a piston which delimits the reservoir to a proximal end and is displaceable into a distal direction relative to the housing in order to discharge the product from the reservoir into the distal direction; and
a press-out element in order to exert a press-out force on the piston into the distal direction, wherein the press-out element is adapted to establish a threaded connection with a counterpart which is arranged proximally to the piston and which is fixed to the housing,
wherein the counterpart which is fixed to the housing is designed so as to be non-detachable and preferably in a single piece with the housing.

18. The device according to claim 17, further comprising:
a mixing element which is movable in the reservoir in order to mix a product accommodated therein.

19. The device according to claim 18, wherein the mixing element is connected to an actuating element which penetrates the piston and projects from the reservoir in the proximal direction in order to move the mixing element in the reservoir.

20. The device according to claim 19, wherein the actuating element comprises a joint in order to remove a proximal part of the actuating element.

21. The device according to claim 18, wherein the press-out element is slidable onto at least part of the actuating element.

22. A device for the mixing and discharging of a product, comprising:
a housing which delimits a reservoir for the product;
a piston which delimits the reservoir to a proximal end and is displaceable into a distal direction relative to the housing in order to discharge the product from the reservoir into the distal direction;
a mixing element which is movable in the reservoir in order to mix a product accommodated therein,
wherein in that the device comprises a fixing device in order to fix the piston relative to the housing at least in terms of movement in the distal direction.

23. The device according to claim 22, comprising an actuating element that is connected to the mixing element, which actuating element penetrates the piston and in the proximal direction projects from the reservoir in order to move the mixing element in the reservoir, wherein the fixing device comprises a coupling element which can be brought to a state in which it fixes the actuating element in terms of at least the distal direction relative to the housing so that the actuating element and/or the mixing element hold/holds the piston at least in terms of the distal direction in a holding position.

24. The device according to claim 23, wherein the coupling element is furthermore designed to move the piston in the reservoir, provided the coupling element is in a state in which it does not fix the actuating element relative to the housing.

25. The device according to claim 23, wherein the coupling element can be attached, proximally from the piston, to the actuating element in such a manner that the piston is held between the coupling element and the mixing element.

26. The device according to claim 23, wherein the actuating element forms an actuating rod, and wherein the coupling element forms a laterally-open hollow piston rod which in a lateral direction can be moved by way of the actuating rod and can be fixed to the actuating rod in such a manner that it rests against the piston.

27. The device according to claim 23, comprising a detachable locking device which in the holding position fixes the coupling element relative to the housing in such a manner that the locking device blocks movement of the coupling element at least in the distal direction, while the locking device in a release position allows movement of the coupling element together with the actuating element in the distal direction.
